(19) United States
(12) Patent Application Publication
(10) Pub. No.: US 2022/0066991 A1
(43) Pub. Date: Mar. 3, 2022

(54) COMMAND LINE UTILITY TO GENERATE USER-CONTROLLED FRAGMENTATED TEST DATA ON A HARD DISK DRIVE

(71) Applicant: MICRO FOCUS LLC, Santa Clara, CA (US)

(72) Inventor: Manoj Sharma, Bangalore (IN)

(21) Appl. No.: 17/009,995

(22) Filed: Sep. 2, 2020

(51) Int. Cl. G06F 16/17; G06F 16/182; G06F 16/13; G06F 11/07; G06F 11/32; G06F 7/58

(52) U.S. Cl. CPC G06F 16/1724; G06F 16/1734; G06F 16/1727; G06F 7/58; G06F 16/13; G06F 11/0772; G06F 11/327; G06F 16/1824

(57) ABSTRACT

Embodiments of the disclosure provide systems and methods for intentionally creating fragmentation of data in one or more storage media based on user-specified parameters. According to one embodiment, a method for creating user-controlled fragmentation of data stored in one or more storage media can comprise receiving a plurality of parameters defining the user-controlled fragmentation of the data stored in the one or more storage media, determining a first random number, and creating a first file on the one or more storage media. The first file can be initially empty. An amount of data for the first file can be determined based on the first random number and data can be written to the first file on the one or more storage media up to the determined amount of data for the first file.

### FIELD OF THE DISCLOSURE

Embodiments of the present disclosure relate generally to methods and systems for software testing environments and more particularly to creating user-controlled fragmentation of data stored in one or more storage media.

### BACKGROUND

Fragmentation of data stored on hard drive or other storage medium often leads to a reduction in performance of input/output operations on that storage medium. There are tools available for de-fragmentation but, even if these tools are used frequently, some amount of fragmentation always exists in enterprise systems and other systems where data is manipulated frequently. This fragmentation can cause degradation of various application using that data. For example, Backup/Restore solutions on fragmented data can be adversely affected. To prevent degradation of performance when operating on fragmented data, there is a need to test and benchmark the performance of applications on fragmented data. Since fragmentation occurs naturally over time when the storage media is used frequently, e.g., creating, deleting and modifying files, creating a test environment with high level of data fragmentation on a storage medium is a challenge, particularly in new systems where data is written in contiguous clusters. Hence, there is a need for improved methods and systems for creating user-controlled fragmentation of data stored in one or more storage media.

### BRIEF SUMMARY

Embodiments of the disclosure provide systems and methods for intentionally creating fragmentation of data in one or more storage media based on user-specified parameters. According to one embodiment, a method for creating user-controlled fragmentation of data stored in one or more storage media can comprise receiving a plurality of parameters defining the user-controlled fragmentation of the data stored in the one or more storage media and determining a first random number. Determining the first random number can comprise generating the first random number within a predefined range for the first random number. The predefined range for the first random number can be based on a target level of fragmentation. A first file can be created on the one or more storage media. The first file can be initially empty. A file index can also be created and initialized prior to creating the first file. An amount of data for the first file can be determined based on the first random number and data can be written to the first file. Determining the amount of data for the first file based on the first random number can comprise multiplying the first random number by a predetermined value. In some cases, the data can be written to a buffer for the first file and from the buffer for the first file to the first file on the one or more storage media in portions of predetermined size up to the determined amount of data for the first file. In response to determining the amount of data equal to or greater than the amount indicated by the parameter indicating the amount of data to write to the one or more storage media has not been written to the one or more storage media, the file index can be incremented.

The plurality of parameters can comprise a parameter indicating an amount of data to be written to the one or more storage media and the method can further comprise determining whether an amount of data equal to greater than the amount indicated by the parameter indicating the amount of data to written to the one or more storage media has been written to the one or more storage media. In response to determining an amount of data equal to or greater than the amount indicated by the parameter indicating the amount of data to write to the one or more storage media has not been written to the one or more storage media, a second random number can be determined, a second file can be created on the one or more storage media, wherein the second file is initially empty, an amount of data for the second file can be determined based on the second random number, data can be written to the second file on the one or more storage media repeatedly until an amount of data equal to greater than the amount indicated by the parameter indicating the amount of data to write to the one or more storage media has been written to the one or more storage media.

The one or more storage media can comprise a hard disk drive. In some cases, the hard disk drive can comprise a one or more hard disk drives of a plurality of hard disk drives and the plurality of parameters can comprise at least one parameter identifying the one or more hard disk drives. In such cases, prior to creating the first file, a determination can be made as to whether the one or more hard disk drives exist. The first file can be created in response to determining the one or more hard disk drives exist. In response to determining the one or more hard disk drives do not exist, an error message can be provided.

The plurality of parameters can comprise a parameter indicating an amount of data to be written to the hard disk drive. In such cases, prior to creating the first file, a determination can be made as to whether an available amount of storage on the one or more storage media is equal to or greater than the amount of data to be written to the one or more storage media. The first file can be created in response to determining the available amount of storage on the one or more storage media is equal to or greater than the amount of data to be written to the one or more storage media. In response to determining the available amount of storage on the one or more storage media is less than the amount of data to be written to the one or more storage media, an error message can be provided.

According to another embodiment, a system can comprise a processor and a memory coupled with and readable by the processor and storing therein a set of instructions which, when executed by the processor, causes the processor to create a user-controlled amount of fragmentation in one or more storage media by receiving a plurality of parameters defining the user-controlled fragmentation of the data stored in the one or more storage media and determining a first random number. Determining the first random number can comprise generating the first random number within a predefined range for the first random number. The predefined range for the first random number can be based on a target level of fragmentation. A first file can be created on the one or more storage media. The first file can be initially empty. A file index can also be created and initialized prior to creating the first file. An amount of data for the first file can be determined based on the first random number and data can be written to the first file. Determining the amount of data for the first file based on the first random number can comprise multiplying the first random number by a predetermined value. Determining the amount of data for the first file based on the first random number can comprise multiplying the first random number by a predetermined value. In some cases, the data can be written to a buffer for the first file and from the buffer for the first file to the first file on the one or more storage media in portions of predetermined size up to the determined amount of data for the first file. The data can be written from the buffer for the first file to the first file on the one or more storage media in portions of predetermined size up to the determined amount of data for the first file. In response to determining the amount of data equal to or greater than the amount indicated by the parameter indicating the amount of data to write to the one or more storage media has not been written to the one or more storage media, the file index can be incrementing.

The plurality of parameters can comprise a parameter indicating an amount of data to be written to the one or more storage media and the instructions can further cause the processor to determine whether an amount of data equal to greater than the amount indicated by the parameter indicating the amount of data to written to the one or more storage media has been written to the one or more storage media. In response to determining an amount of data equal to or greater than the amount indicated by the parameter indicating the amount of data to write to the one or more storage media has not been written to the one or more storage media, a second random number can be determined, a second file can be created on the one or more storage media, wherein the second file is initially empty, an amount of data for the second file can be determined based on the second random number, data can be written to the second file on the one or more storage media up to the determined amount of data for the first file repeatedly until an amount of data equal to greater than the amount indicated by the parameter indicating the amount of data to write to the one or more storage media has been written to the one or more storage media.

The one or more storage media can comprise a one or more hard disk drives of a plurality of hard disk drives and the plurality of parameters can comprise at least one parameter identifying the one or more hard disk drives. In such cases, the instructions can further cause the processor to, prior to creating the first file, determine whether the one or more hard disk drives exist. The first file can be created in response to determining the one or more hard disk drives exist. In response to determining the one or more hard disk drives do not exist, an error message can be provided.

The plurality of parameters can comprise a parameter indicating an amount of data to be written to the hard disk drive and the instructions further cause the processor to, prior to creating the first file, determine whether an available amount of storage on the hard disk drive is equal to or greater than the amount of data to be written to the hard disk drive. The first file can be created in response to determining the available amount of storage on the hard disk drive is equal to or greater than the amount of data to be written to the hard disk drive. In response to determining the available amount of storage on the hard disk drive is less than the amount of data to be written to the hard disk drive, an error message can be provided.

According to yet another embodiment, a non-transitory, computer-readable medium can comprise a set of instructions stored therein which, when executed by a processor, causes the processor to create user-controlled fragmentation of data stored in one or more storage media by receiving a plurality of parameters defining the user-controlled fragmentation of the data stored in the one or more storage media, determining a first random number, and creating a first file on the one or more storage media. The first file can be initially empty. The instructions can further cause the processor to create a file index prior to creating the first file and initialize the file index. An amount of data for the first file can be determined based on the first random number, data can be written to the first file on the one or more storage media up to the determined amount of data for the first file. In some cases, the data can be written to a buffer for the first file and from the buffer for the first file to the first file on the one or more storage media in portions of predetermined size up to the determined amount of data for the first file. In response to determining the amount of data equal to or greater than the amount indicated by the parameter indicating the amount of data to write to the one or more storage media has not been written to the one or more storage media, the file index can be incremented.

The plurality of parameters comprises a parameter indicating an amount of data to be written to the one or more storage media and the instructions further cause the processor to determine whether an amount of data equal to greater than the amount indicated by the parameter indicating the amount of data to written to the one or more storage media has been written to the one or more storage media. In response to determining an amount of data equal to or greater than the amount indicated by the parameter indicating the amount of data to write to the one or more storage media has not been written to the one or more storage media a second random number can be determined, a second file can be created on the one or more storage media, wherein the second file is initially empty, an amount of data for the second file can be determined based on the second random number, data can be written to the second file on the one or more storage media up to the determined amount of data for the first file repeatedly until an amount of data equal to greater than the amount indicated by the parameter indicating the amount of data to write to the one or more storage media has been written to the one or more storage media.

The plurality of parameters can comprise a parameter indicating an amount of data to be written to the hard disk drive and the instructions can further cause the processor to, prior to creating the first file, determine whether an available amount of storage on the hard disk drive is equal to or greater than the amount of data to be written to the hard disk drive. The first file can be created in response to determining the available amount of storage on the hard disk drive is equal to or greater than the amount of data to be written to the hard disk drive. In response to determining the available amount of storage on the hard disk drive is less than the amount of data to be written to the hard disk drive, an error message can be provided.

### BRIEF DESCRIPTION OF THE DRAWINGS

FIG. 1 is a block diagram illustrating elements of an exemplary computing environment in which embodiments of the present disclosure may be implemented.

FIG. 2 is a block diagram illustrating elements of an exemplary computing device in which embodiments of the present disclosure may be implemented.

FIG. 3 is a block diagram illustrating elements of an exemplary system for creating user-controlled fragmentation of data in one or more storage media according to one embodiment of the present disclosure.

FIG. 4 is a flowchart illustrating an exemplary process for creating user-controlled fragmentation of data in one or more storage media according to one embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programmable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL), special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

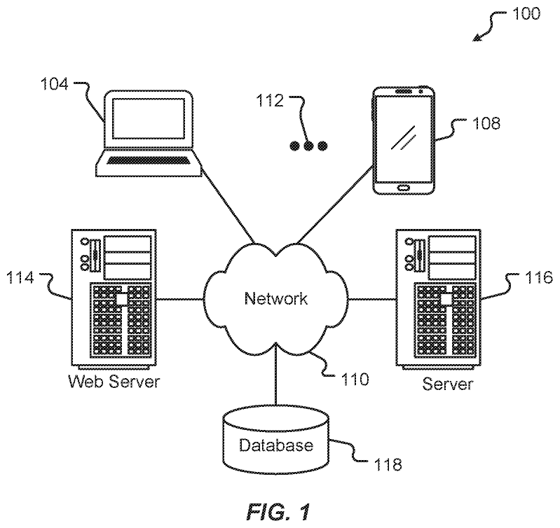

FIG. 1 is a block diagram illustrating elements of an exemplary computing environment in which embodiments of the present disclosure may be implemented. More specifically, this example illustrates a computing environment 100 that may function as the servers, user computers, or other systems provided and described herein. The environment 100 includes one or more user computers, or computing devices, such as a computing device 104, a communication device 108, and/or more 112. The computing devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 104, 108, 112 may also have any of a variety of applications, including for example, database client and/or server applications, and web browser applications. Alternatively, the computing devices 104, 108, 112 may be any other electronic device, such as a thin-client computer, Internet-enabled mobile telephone, and/or personal digital assistant, capable of communicating via a network 110 and/or displaying and navigating web pages or other types of electronic documents. Although the exemplary computer environment 100 is shown with two computing devices, any number of user computers or computing devices may be supported.

Environment 100 further includes a network 110. The network 110 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 114, 116. In this example, server 114 is shown as a web server and server 116 is shown as an application server. The web server 114, which may be used to process requests for web pages or other electronic documents from computing devices 104, 108, 112. The web server 114 can be running an operating system including any of those discussed above, as well as any commercially-available server operating systems. The web server 114 can also run a variety of server applications, including SIP servers, HyperText Transfer Protocol (secure) (HTTP(s)) servers, FTP servers, CGI servers, database servers, Java servers, and the like. In some instances, the web server 114 may publish operations available operations as one or more web services.

The environment 100 may also include one or more file and or/application servers 116, which can, in addition to an operating system, include one or more applications accessible by a client running on one or more of the computing devices 104, 108, 112. The server(s) 116 and/or 114 may be one or more general purpose computers capable of executing programs or scripts in response to the computing devices 104, 108, 112. As one example, the server 116, 114 may execute one or more web applications. The web application may be implemented as one or more scripts or programs written in any programming language, such as Java™, C, C#®, or C++, and/or any scripting language, such as Perl, Python, or Tool Command Language (TCL), as well as combinations of any programming/scripting languages. The application server(s) 116 may also include database servers, including without limitation those commercially available from Oracle®, Microsoft®, Sybase®, IBM® and the like, which can process requests from database clients running on a computing device 104, 108, 112.

The web pages created by the server 114 and/or 116 may be forwarded to a computing device 104, 108, 112 via a web (file) server 114, 116. Similarly, the web server 114 may be able to receive web page requests, web services invocations, and/or input data from a computing device 104, 108, 112 (e.g., a user computer, etc.) and can forward the web page requests and/or input data to the web (application) server 116. In further embodiments, the server 116 may function as a file server. Although for ease of description, FIG. 1 illustrates a separate web server 114 and file/application server 116, those skilled in the art will recognize that the functions described with respect to servers 114, 116 may be performed by a single server and/or a plurality of specialized servers, depending on implementation-specific needs and parameters. The computer systems 104, 108, 112, web (file) server 114 and/or web (application) server 116 may function as the system, devices, or components described herein.

The environment 100 may also include a database 118. The database 118 may reside in a variety of locations. By way of example, database 118 may reside on a storage medium local to (and/or resident in) one or more of the computers 104, 108, 112, 114, 116. Alternatively, it may be remote from any or all of the computers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers 104, 108, 112, 114, 116 may be stored locally on the respective computer and/or remotely, as appropriate. The database 118 may be a relational database, such as Oracle 20i®, that is adapted to store, update, and retrieve data in response to Structured Query Language (SQL) formatted commands.

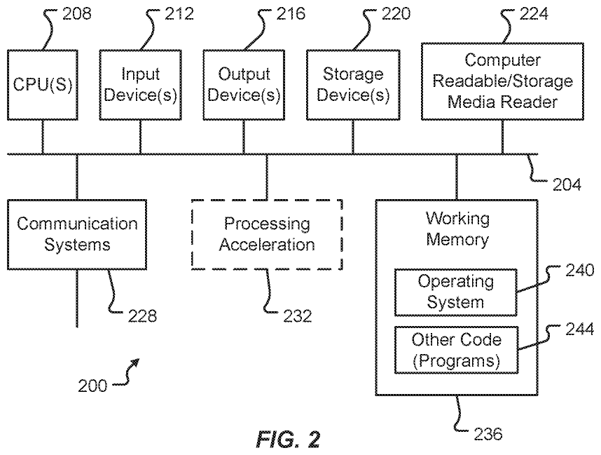

FIG. 2 is a block diagram illustrating elements of an exemplary computing device in which embodiments of the present disclosure may be implemented. More specifically, this example illustrates one embodiment of a computer systems 200 upon which the servers, user computers, computing devices, or other systems or components described above may be deployed or executed. The computer system 200 is shown comprising hardware elements that may be electrically coupled via a bus 204. The hardware elements may include one or more Central Processing Units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

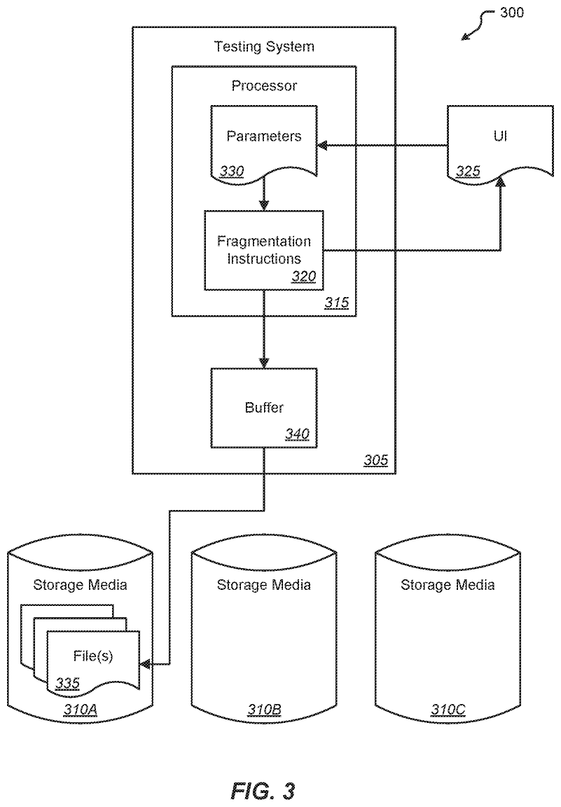

FIG. 3 is a block diagram illustrating elements of an exemplary system for creating user-controlled fragmentation of data in one or more storage media according to one embodiment of the present disclosure. As illustrated in this example, the system 300 can include a testing system such as any of the servers or other computing devices as described above. The system 300 can also include any number of storage devices or media 310A-310C. In one embodiment, the storage media 310A-310C can comprise one or more hard disk drives however, in other embodiments, other types of storage devices and media may additionally, or alternatively, be used. The media can store a wide variety of data such as application data for any number and/or types of applications executing on one or more servers and/or computing devices (not shown here) as described above. The storage media 310A-310C can be accessible by the testing system 305 and any other servers and/or computing devices via one or more networks (not shown here) as described above.

The testing system 305 can comprise a processor 315 such as any of the processors described above, for example. The processor can execute a set of fragmentation functions 320. Generally speaking, the fragmentation functions 320 can be adapted to intentionally, and based on user input, create fragmented data in one or more of the storage media 310A-310C for the purpose of testing another application (not shown here) executed by the testing system 305 or other system. Accordingly, the fragmentation functions 320 can provide a user interface 325 through which the user can input parameters 330 indicating an amount of fragmented data to be created on one or more of the storage media 310A-310C. The user interface 325 can comprise, in one embodiment, a command line utility of an operating system of the testing system 305. However, in other embodiments, the user interface 325 can comprise another type of graphical and/or textual interface.

More specifically, the fragmentation functions 320 can, when executed by the processor 315, cause the processor to creating user-controlled fragmentation of data stored in one or more storage media 310A by receiving, through the user interface 325, a plurality of parameters 330 defining the user-controlled fragmentation of the data stored in the one or more storage media. In some cases, the plurality of parameters can comprise at least one parameter identifying the one or more storage media 310A. For example, the one or more storage media 310A comprises a hard disk drive. In some cases, the hard disk drive 310A can comprise a one or more hard disk drives of a plurality hard disk drives 310A-310C and the plurality of parameters 330 can comprise at least one parameter identifying the one or more hard disk drives 31A, e.g., a drive letter, number, or other identifier. In such cases, the fragmentation functions 320 can cause the processor 315 to make a determination 410 as to whether the first one or more storage media 310A exists or other identified medium exists on or in communication with the testing system 305. In response to determining the first one or more storage media 310A does not exist, the fragmentations functions 320 can cause the processor 315 to provide, e.g., through the user interface 325, an error message. For example, the error message can comprise a prompt requesting entry of a valid hard disk drive or other one or more storage media.

Additionally, or alternatively, the plurality of parameters 330 can comprise a parameter indicating an amount of fragmented data to be written to the one or more storage media 310A. In response to determining the first one or more storage media 310A does exist, the fragmentation functions 320 can cause the processor 315 to make a further determination 420 as to whether an available amount of storage on the one or more storage media is equal to or greater than the amount of data to be written to the one or more storage media. In response to determining the available amount of storage on the one or more storage media 310A is less than the amount of data to be written to the one or more storage media 310A, the fragmentations functions 320 can cause the processor 315 to provide, e.g., through the user interface 325, an error message. For example, the error message can comprise a prompt requesting entry of an amount of data less than the available storage.

In response to determining the first one or more storage media 310A does exist and determining that the available amount of storage on the one or more storage media is equal to or greater than the amount of data to be written to the one or more storage media, The fragmentation functions 320 can cause the processor to determine a random number and create a file 335 on the one or more storage media 310A. Determining the random number can comprises generating the random number within a predefined range for the random number. For example, the range can have a lower value of approximately 100000 and an upper value of approximately 3200000. The predefined range for the random number can be based on a target level of fragmentation to be achieved and can be determined and adjust based on results. In other cases, determining the random number can comprise receiving the random number from a user, e.g., in response to a prompt which may, for example, indicate the range for the expected random number. Creating the file 335 can comprise creating and initializing a file index prior to creating the file. The file can initially be empty.

The fragmentation functions 320 can further causes the processor 305 to determine an amount of data for the file 335, i.e., the size of the first, based on the first random number. For example, determining the amount of data for the first file based on the first random number may comprise multiplying the random number by a predetermined value. In other examples, the amount of data for the first file may be determined using other functions including, but not limited to addition, subtraction, division, etc. The predetermined value can be approximately 9 bytes, for example, but may be adjusted depending upon the amount of fragmentation desired and balanced against performance. The fragmentations functions 320 can cause the processor 315 to write data to the file 335. In some cases, the fragmentation functions 320 can cause the processor 315 to write data to the file 335 through a buffer 340. That is, data can be written to a buffer 340 for the file 335 and the data can be written from the buffer 340 to the file 335 on the one or more storage media 310A in portions of predetermined size, e.g., based on the size and/or speed of the buffer 340 etc., up to the determined amount of data for the file 310A. Accordingly, the fragmentations functions 320 can cause the processor 315 to make a determination as to whether the determined amount of data for the file 335 has been written to the file 335. In response to determining the determined amount of data for the file 335 has not yet been written to the file 335, data can continue to be written to the file 335 through a buffer 340.

In response to determining the determined amount of data for the file 335 has been written to the file 335, the fragmentation functions 320 can cause the processor 315 to make a further determination as to whether an amount of data equal to or greater than the amount indicated by the parameter indicating the amount of data to written to the one or more storage media 310A has been written to the one or more storage media 310A. In response to determining an amount of data equal to or greater than the amount indicated by the parameter indicating the amount of data to write to the one or more storage media 310A has not been written to the one or more storage media 310A, the fragmentation functions 320 can cause the processor 315 to increment the file index, determine another random number, create another, initially empty file 335 on the one or more storage media 310A, determine an amount of data for the file based on the random number, and write data to the file 335, directly or perhaps through the buffer 340, repeatedly until an amount of data equal to greater than the amount indicated by the parameter indicating the amount of data to write to the one or more storage media 310A has been written to the one or more storage media 310A. Once an amount of data equal to or greater than the amount indicated by the parameter indicating the amount of data to write to the one or more storage media 310A has been written to the one or more storage media 310A, the fragmentation functions 320 can stop processing the now fragmented data on the one or more storage media 310A can be made available for use in testing an application.

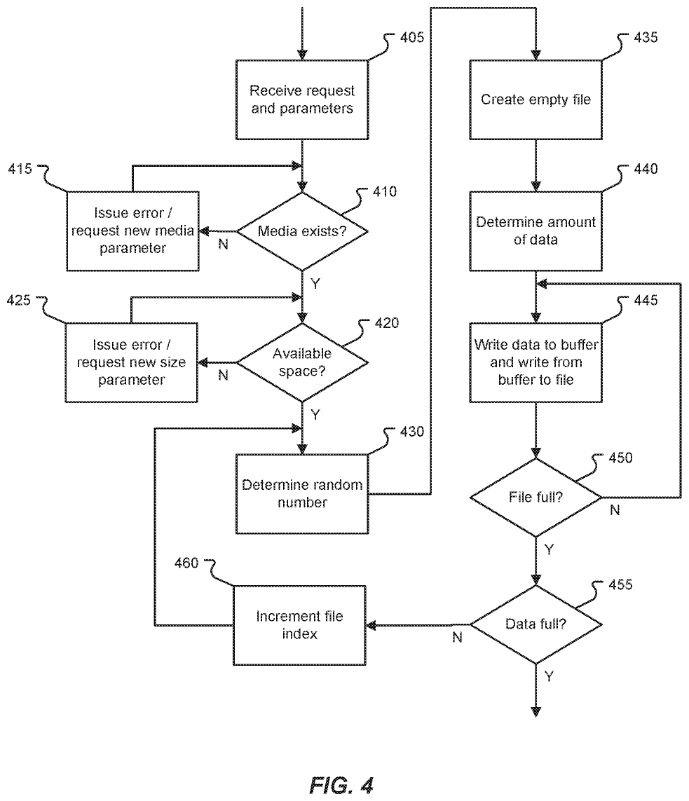

FIG. 4 is a flowchart illustrating an exemplary process for creating user-controlled fragmentation of data in one or more storage media according to one embodiment of the present disclosure. As illustrated in this example, creating user-controlled fragmentation of data stored in one or more storage media can comprise receiving 405 a plurality of parameters defining the user-controlled fragmentation of the data stored in the one or more storage media. In some cases, the plurality of parameters can comprise at least one parameter identifying the one or more storage media. For example, the one or more storage media comprises a hard disk drive. In some cases, the hard disk drive can comprise a one or more hard disk drives of a plurality of hard disk drives and the plurality of parameters comprises at least one parameter identifying the one or more hard disk drives. In such cases, a determination 410 can be made as to whether the one or more hard disk drives exist or other identified medium exists on or in communication with the system. In response to determining 410 the one or more hard disk drives do not exist, an error message can be provided 415. For example, the error message may request entry of a valid hard disk drive or other one or more storage media.

Additionally, or alternatively, the plurality of parameters can comprise a parameter indicating an amount of data to be written to the one or more storage media. In response to determining 410 the one or more hard disk drives do exist, a further determination 420 can be made as to whether an available amount of storage on the one or more storage media is equal to or greater than the amount of data to be written to the one or more storage media. In response to determining 420 the available amount of storage on the one or more storage media is less than the amount of data to be written to the one or more storage media, an error message can be provided 425. For example, the error message may request entry of an amount of data less than the available storage.

In response to determining 410 the one or more hard disk drives do exist and determining 420 the available amount of storage on the one or more storage media is equal to or greater than the amount of data to be written to the one or more storage media, a first random number can be determined 430 and a first file can be created 435 on the one or more storage media. Determining 430 the random number can comprises generating the random number within a predefined range for the random number. The predefined range for the random number can be based on a target level of fragmentation. In other cases, determining 430 the random number can comprise receiving the random number from a user, e.g., in response to a prompt which may, for example, indicate the range for the expected random number. Creating 435 the first file can comprise creating and initializing a file index prior to creating the first file. The first file can initially be empty.

An amount of data for the first file, i.e., the size of the first file, can be determined 440 based on the first random number. For example, determining 440 the amount of data for the first file based on the first random number comprising multiplying the first random number by a predetermined value. In other examples, the amount of data for the first file may be determined using other functions including, but not limited to addition, subtraction, division, etc. Data can then be written 445 to the first file. In some cases, the data may be written 445 directly to the file. In other cases, data can be written to a buffer for the first file and the data can be written from the buffer for the first file to the first file on the one or more storage media in portions of predetermined size up to the determined amount of data for the first file. Accordingly, a determination 450 can be made as to whether the determined amount of data for the first file has been written to the first file. In response to determining 450 the determined amount of data for the first file has not yet been written to the first file, data can continue to be written 445 to the first file directly or through a buffer.

In response to determining 450 the determined amount of data for the first file has been written to the first file, a further determination 455 can be made as to whether an amount of data equal to or greater than the amount indicated by the parameter indicating the amount of data to written to the one or more storage media has been written to the one or more storage media. In response to determining 455 an amount of data equal to or greater than the amount indicated by the parameter indicating the amount of data to write to the one or more storage media has not been written to the one or more storage media, the file index can be incremented 460, a second random number can be determined 430, a second, initially empty file can be created 435 on the one or more storage media, an amount of data for the second file can be determined 440 based on the second random number, and data can then be written 445 to the first file, directly or through a buffer, repeatedly until an amount of data equal to greater than the amount indicated by the parameter indicating the amount of data to write to the one or more storage media has been written to the one or more storage media. Once a determination 455 is made that an amount of data equal to or greater than the amount indicated by the parameter indicating the amount of data to write to the one or more storage media has been written to the one or more storage media, processing can end and testing of an application can be performed using the now fragmented data on the one or more storage media.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for creating user-controlled fragmentation of data stored in one or more storage media, the method comprising:
receiving, by a processor, a plurality of parameters defining the user-controlled fragmentation of the data stored in the one or more storage media;
determining, by the processor, a first random number;
creating, by the processor, a first file on the one or more storage media, wherein the first file is initially empty;
determining, by the processor, an amount of data for the first file based on the first random number; and
writing, by the processor, data to the first file on the one or more storage media up to the determined amount of data for the first file.

2. The method of claim 1, wherein the plurality of parameters comprises a parameter indicating an amount of data to be written to the one or more storage media and wherein the method further comprising:
determining, by the processor, whether an amount of data equal to greater than the amount indicated by the parameter indicating the amount of data to written to the one or more storage media has been written to the one or more storage media;
in response to determining an amount of data equal to or greater than the amount indicated by the parameter indicating the amount of data to write to the one or more storage media has not been written to the one or more storage media:
determining, by the processor, a second random number,
creating, by the processor, a second file on the one or more storage media, wherein the second file is initially empty,
determining, by the processor, an amount of data for the second file based on the second random number,
writing, by the processor, data to the second file on the one or more storage media up to the determined amount of data for the second file, and
repeating, by the processor, determining a random number, creating a file on the one or more storage media, determining an amount of data for the file, writing data to the file on the one or more storage media up to the determined amount of data for the file has been written to the one or more storage media.

3. The method of claim 2, further comprising:
creating, by the processor, a file index prior to creating the first file;
initializing, by the processor, the file index; and
in response to determining the amount of data equal to or greater than the amount indicated by the parameter indicating the amount of data to write to the one or more storage media has not been written to the one or more storage media, incrementing, by the processor, the file index prior to creating the second file.

4. The method of claim 1, wherein determining the first random number comprises generating the first random number within a predefined range for the first random number, wherein the predefined range for the first random number is based on a target level of fragmentation.

5. The method of claim 1, wherein determining the amount of data for the first file based on the first random number comprising multiplying the first random number by a predetermined value.

6. The method of claim 1, wherein writing data to the first file on the one or more storage media up to the determined amount of data for the first file comprises:
writing, by the processor, the data to a buffer for the first file; and
writing, by the processor, the data from the buffer for the first file to the first file on the one or more storage media in portions of predetermined size up to the determined amount of data for the first file.

7. The method of claim 6, wherein the storage media comprises one or more hard disk drives of a plurality of hard disk drives and wherein the plurality of parameters comprises at least one parameter identifying the one or more hard disk drives.

8. The method of claim 7, further comprising:
prior to creating the first file, determining, by the processor, whether the one or more hard disk drives exist, wherein the first file is created in response to determining the one or more hard disk drives exist; and
in response to determining the one or more hard disk drives do not exist, providing, by the processor an error message.

9. The method of claim 1, wherein the plurality of parameters comprises a parameter indicating an amount of data to be written to the one or more storage media and the method further comprises:
prior to creating the first file, determining, by the processor, whether an available amount of storage on the one or more storage media is equal to or greater than the amount of data to be written to the one or more storage media, wherein the first file is created in response to determining the available amount of storage on the one or more storage media is equal to or greater than the amount of data to be written to the one or more storage media; and
in response to determining the available amount of storage on the one or more storage media is less than the amount of data to be written to the one or more storage media, providing, by the processor an error message.

10. A system comprising:
a processor; and
a memory coupled with and readable by the processor and storing therein a set of instructions which, when executed by the processor, causes the processor to create a user-controlled amount of fragmentation in one or more storage media by:
receiving a plurality of parameters defining the user-controlled fragmentation of the data stored in the one or more storage media;
determining a first random number;
creating a first file on the one or more storage media, wherein the first file is initially empty;
determining an amount of data for the first file based on the first random number; and
writing, by the processor, data to the first file on the one or more storage media up to the determined amount of data for the first file.

11. The system of claim 10, wherein the plurality of parameters comprises a parameter indicating an amount of data to be written to the one or more storage media and wherein the instructions further cause the processor to:
determine whether an amount of data equal to greater than the amount indicated by the parameter indicating the amount of data to written to the one or more storage media has been written to the one or more storage media;
in response to determining an amount of data equal to or greater than the amount indicated by the parameter indicating the amount of data to write to the one or more storage media has not been written to the one or more storage media:
determine a second random number,
create a second file on the one or more storage media, wherein the second file is initially empty,
determine an amount of data for the second file based on the second random number,
writing, by the processor, data to the second file on the one or more storage media up to the determined amount of data for the second file, and
repeat determining a random number, creating a file on the one or more storage media, determining an amount of data for the file, writing data to the file on the one or more storage media up to the determined amount of data for the file until an amount of data equal to greater than the amount indicated by the parameter indicating the amount of data to write to the one or more storage media has been written to the one or more storage media.

12. The system of claim 11, wherein the instructions further cause the processor to:
create a file index prior to creating the first file;
initialize the file index; and
in response to determining the amount of data equal to or greater than the amount indicated by the parameter indicating the amount of data to write to the one or more storage media has not been written to the one or more storage media, increment the file index prior to creating the second file.

13. The system of claim 10, wherein determining the first random number comprises generating the first random number within a predefined range for the first random number, wherein the predefined range for the first random number is based on a target level of fragmentation.

14. The system of claim 10, wherein writing data to the first file on the one or more storage media up to the determined amount of data for the first file comprises:
writing, by the processor, the data to a buffer for the first file; and
writing, by the processor, the data from the buffer for the first file to the first file on the one or more storage media in portions of predetermined size up to the determined amount of data for the first file.

15. The system of claim 10, wherein the one or more storage media comprises a one or more hard disk drives of a plurality of hard disk drives, wherein the plurality of parameters comprises at least one parameter identifying the one or more hard disk drives, and wherein the instructions further cause the processor to, prior to creating the first file, determine whether the one or more hard disk drives exist, wherein the first file is created in response to determining the one or more hard disk drives exist and in response to determining the one or more hard disk drives do not exist, provide an error message.

16. The system of claim 10, wherein the plurality of parameters comprises a parameter indicating an amount of data to be written to the one or more storage media and the instructions further cause the processor to:
prior to creating the first file, determine whether an available amount of storage on the one or more storage media is equal to or greater than the amount of data to be written to the one or more storage media, wherein the first file is created in response to determining the available amount of storage on the one or more storage media is equal to or greater than the amount of data to be written to the one or more storage media; and
in response to determining the available amount of storage on the one or more storage media is less than the amount of data to be written to the one or more storage media, provide an error message.

17. A non-transitory, computer-readable medium comprising a set of instructions stored therein which, when executed by a processor, causes the processor to create user-controlled fragmentation of data stored in one or more storage media by:
receiving a plurality of parameters defining the user-controlled fragmentation of the data stored in the one or more storage media;
determining a first random number;
creating a first file on the one or more storage media, wherein the first file is initially empty;
determining an amount of data for the first file based on the first random number; and
writing data to the first file on the one or more storage media up to the determined amount of data for the first file.

18. The non-transitory, computer-readable medium of claim 17, wherein the plurality of parameters comprises a parameter indicating an amount of data to be written to the one or more storage media and wherein the instructions further cause the processor to:
determine whether an amount of data equal to greater than the amount indicated by the parameter indicating the amount of data to written to the one or more storage media has been written to the one or more storage media;
in response to determining an amount of data equal to or greater than the amount indicated by the parameter indicating the amount of data to write to the one or more storage media has not been written to the one or more storage media:
determine a second random number,
create a second file on the one or more storage media, wherein the second file is initially empty,
determine an amount of data for the second file based on the second random number,
write data to the second file on the one or more storage media up to the determined amount of data for the second file, and
repeat determining a random number, creating a file on the one or more storage media, determining an amount of data for the file, writing data to the file on the one or more storage media up to the determined amount of data for the file until an amount of data equal to greater than the amount indicated by the parameter indicating the amount of data to write to the one or more storage media has been written to the one or more storage media.

19. The non-transitory, computer-readable medium of claim 18, wherein the instructions further cause the processor to:
create a file index prior to creating the first file;
initialize the file index; and
in response to determining the amount of data equal to or greater than the amount indicated by the parameter indicating the amount of data to write to the one or more storage media has not been written to the one or more storage media, increment the file index prior to creating the second file.

20. The non-transitory, computer-readable medium of claim 17, wherein the plurality of parameters comprises a parameter indicating an amount of data to be written to the one or more storage media and the instructions further cause the processor to:
prior to creating the first file, determine whether an available amount of storage on the one or more storage media is equal to or greater than the amount of data to be written to the one or more storage media, wherein the first file is created in response to determining the available amount of storage on the one or more storage media is equal to or greater than the amount of data to be written to the one or more storage media; and
in response to determining the available amount of storage on the one or more storage media is less than the amount of data to be written to the one or more storage media, provide an error message.
